(19) United States
(12) Patent Application Publication
(10) Pub. No.: US 2021/0034720 A1
(43) Pub. Date: Feb. 4, 2021

(54) AUTOMATED DOCUMENT MANAGEMENT SYSTEM

(71) Applicant: ADMA Biologics, Inc., Ramsey, NJ (US)

(72) Inventors: Adam Pinkert, Ramsey, NJ (US); Amir Ben Ishay, Ramsey, NJ (US); Moshe Holtzberg, Ramsey, NJ (US)

(21) Appl. No.: 16/526,106

(22) Filed: Jul. 30, 2019

(51) Int. Cl. G06F 21/16; G06F 16/93

(52) U.S. Cl. CPC G06F 21/16; G06F 2221/0737; G06F 16/93

(57) ABSTRACT

The present disclosure relates to automated systems and methods for document management. In particular, the disclosure relates to automated document management systems and methods for data management that allow for cost-effective application of anti-counterfeit features and page by page identification within a document.

### FIELD

The present disclosure relates to automated systems and methods for document management. In particular, the disclosure relates to automated document management systems and methods for data management that allow for cost-effective application of anti-counterfeit features and page by page identification within a document.

### BACKGROUND

Data integrity refers to the completeness, consistency, and accuracy of data. Complete, consistent, and accurate data should be attributable, legible, contemporaneously recorded, original or a true copy, and accurate. Data integrity is critical throughout the comprehensive good laboratory practice (CGMP) data life cycle, including in the creation, modification, processing, maintenance, archival, retrieval, transmission, and disposition of data after the record's retention period ends. System design and controls should enable easy detection of errors, omissions, and aberrant results throughout the data's life cycle.

Current solutions for data integrity systems, particularly within the pharmaceutical industry, are inefficient and highly expensive. Documents may be required to be printed on expensive pantographic paper in order to be able to readily prevent and detect photocopying. Additionally, documents may only be assigned a unique serial number per document, rather than on each page, thus not effectively tracking the issuance and reconciliation of each page within the document. Alternatively, manual systems may be used to track and reconcile each page of a document, but such systems require the use of hand scanners and manual reconciliation and are therefore time consuming and labor intensive. Accordingly, new systems and methods for data integrity are needed.

### BRIEF SUMMARY

The present disclosure relates to systems and methods for document issuance and reconciliation.

In one aspect, provided herein are automated document management systems. In some embodiments, the automated document management system includes computer-readable code configured to perform multiple steps in response to selection of a document by a user. The steps include applying one or more anti-counterfeit features and a unique identifier to each page of the document to produce a marked document, issuing the marked document to the user, and reconciling a copy of the marked document with the marked document issued to the user.

In some embodiments, the automated document management system includes a processor, computer-readable code, and a document library. The computer readable code may be configured to instruct the processor to perform the multiple steps in response to selection of a document from the document library by a user. These steps include applying one or more anti-counterfeit features and a unique identifier to each page of the document to produce a marked document, issuing the marked document to the user, and reconciling a copy of the marked document with the marked document issued to the user.

In another aspect, provided herein are computer-implemented methods for document management. The methods include detecting user selection of a document, applying one or more anti-counterfeit features and a unique identifier to each page of the document to produce a marked document, issuing the marked document to the user, and reconciling a copy of the marked document with the marked document issued to the user.

In some embodiments described herein, no two pages of the document comprise the same unique identifier. Each unique identifier includes a user identification feature and a page identification feature. The identification feature may include a user pin number, a user serial number, a user fingerprint, or a combination thereof. The page identification feature may include a page number, a page serial number, a page pin number, or a combination thereof.

In another aspect, provided herein are methods for managing documents. The methods include using the automated document management system described herein.

Additional objects, features, and advantages of the present disclosure will become apparent from the following detailed description. It should be understood, however, that the detailed description and specific examples, while indicating preferred embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

FIG. 1 is a flow chart broadly illustrating an embodiment of a computer-implemented method for document management as described herein. The method comprises detection (100) of user selection of a document, application (110) of one or more anti-counterfeit features and a unique identifier to each page of the document, issuance (120) of the marked document to the user, and reconciliation (130) of a copy of the marked document.

FIG. 2 is a flow chart broadly illustrating an embodiment of an automated system for document management as described herein. The system comprises computer-readable code (210) configured to detect user selection (200) of a document. Upon detecting user selection (200), the computer-readable code (210) is configured to mark the document (220) with one or more anti-counterfeit features and a unique identifier on each page, issue the document (230) to the user, and reconcile (240) a copy of the document with the marked document originally issued (230) to the user.

FIG. 3 is a flow chart broadly illustrating an embodiment of an automated system for document management as described herein. The system comprises computer-readable code (310) configured to detect user selection (300) of a document. Upon detecting user selection (300), the computer-readable code (310) is configured to instruct a processor (320) to mark the document (330) with one or more anti-counterfeit features and a unique identifier on each page, issue the document (340) to the user, reconcile (350) a copy of the document with the marked document originally issued (340) to the user, and archive (360) a copy of the reconciled document.

### DETAILED DESCRIPTION

### 1. Definitions

Unless otherwise defined, all technical terms used herein have the same meaning as commonly understood by one of ordinary skill in the art to which this disclosure belongs. However, in case of conflict, the present specification, including definitions, will control. Accordingly, in the context of the embodiments described herein, the following definitions apply.

As used herein and in the appended claims, the singular forms “a”, “an” and “the” include plural reference unless the context clearly dictates otherwise.

As used herein, the terms “comprise”, “include”, and linguistic variations thereof denote the presence of recited feature(s), element(s), method step(s), etc. without the exclusion of the presence of additional feature(s), element(s), method step(s), etc.

As used herein, the term “document” refers to any document selected by a user. For example, the document may contain laboratory data, such as CGLP data. The document may be one page or multiple pages. The document may be stored in a document library. The document library may be found in any suitable location, including in a document folder, an internal hard-drive of the automated document management system, an external hard-drive connected to the automated document management system, and the like.

As used herein, the term “copy” indicates a version of a document that is not the original document issued to the user. In some embodiments, a copy of a document may be a paper copy of the document, such as a paper copy generated by using a scanner. In other embodiments, a copy of a document may be an electronic copy of a document. A copy of a document may be generated using any suitable device. For example, a copy of a document may be generated using a scanner that forms an integrated network with the automated document management system. A scanner that forms an integrated network with the automated document management system is also referred to herein as a “network scanner.” A network scanner may form an integrated network with the automated document management system and one or more printers.

As used herein, the term “issue” refers to any suitable means of providing a document to a user. In some embodiments, the issuing a document refers to printing a document. For example, the term “issue” may refer to printing a document on a printer that forms an integrated network with the automated document management system. A printer that forms an integrated network with the automated document management system is referred to herein as a “network printer”. A “network printer” may form an integrated network with the automated document management system and one or more scanners. In other embodiments, the term “issue” may refer to other means of providing a document to a user, including electronic transmission of a document to a user (e.g. a document may be printed electronically, for example, into an electronic format (e.g., Portable Document Format (PDF)) to present and exchange the document in a reliable and accessible manner). For example, the term “issue” may refer to e-mailing the document to the user, sending a link providing access to a downloadable copy of the document to the user, etc. Following such forms of issuance, the user may be able to print the document from a suitable computer.

As used herein, the terms “marked document” refers to a document wherein each page comprises one or more anti-counterfeit features and/or a unique identifier.

As used herein, the term “reconcile”, “reconciles”, “reconciliation”, and linguistic variations thereof refers to the process of comparing a copy of a document to the document originally issued to the user. For example, “reconciliation” may comprise comparing the unique identifier on each page of a copy of the marked document to the unique identifier on each page of the marked document originally issued to the user. Alternatively or in combination, reconciliation may comprise comparing one or more anti-counterfeit features on each page of a copy of the marked document to the one or more anti-counterfeit features on each page of the marked document originally issued to the user. The copy of the document may be a scanned copy (e.g. a paper copy of the document). Alternatively, the copy of the document may be an electronic copy of the document.

As used herein, the term “user” refers to an individual. The individual may be the person using an automated document management system disclosed herein to request and/or reconcile a document. The individual may be a person performing a method for document management as disclosed herein. In some embodiments, the user is a specific employee of a company using the disclosed automated document management systems or methods for document management.

As used herein, the term “unique identifier” refers to the entity comprising a user identification feature (e.g. user pin number, a user serial number, a user fingerprint, a user passcode, a unique employee badge number, and the like) and a page identification feature (e.g. a page number, a page serial number, a page pin number, and the like).

### 2. Systems and Methods for Document Management

Disclosed herein are automated document management systems and methods for document management. The disclosed systems and methods may be used in an effort to maintain data integrity, such as data integrity within industries requiring comprehensive good lab practice (cGMP). In particular, the disclosed systems may be used in an effort to maintain data integrity within the pharmaceutical industry. In some embodiments, the automated document management systems disclosed herein allow integration with standard network copiers and/or printers, cost-effective application of anti-counterfeit features, page by page identification, and/or automatic reconciliation of each page within a document.

In one aspect, disclosed herein are automated document management systems. In some embodiments, the automated document management systems comprise computer-readable code. The computer-readable code is configured to perform several steps in response to selection of a document by a user. For example, the computer-readable code may be configured to apply one or more anti-counterfeit features and/or a unique identifier to each page of the document to produce a marked document, issue the marked document to the user, and reconcile a copy of the marked document with the marked document issued to the user. In some embodiments, no two pages of the document comprise the same unique identifier.

In some embodiments, the automated document management systems disclosed herein comprise a processor, computer-readable code, and a document library. The computer-readable code may be stored in a memory. The computer-readable code may be executed using software, hardware, or a combination thereof. The computer-readable code is configured to instruct the automated document management system to perform several steps in response to selection of a document from the document library by a user. For example, the computer-readable code is configured to instruct the automated document management system to apply one or more anti-counterfeit features and/or a unique identifier to each page of the document to produce a marked document, issue the marked document to the user, and reconcile a copy of the marked document with the marked document issued to the user. In some embodiments, no two pages of the document comprise the same unique identifier.

In another aspect, disclosed herein are methods for document management. In some embodiments, the methods comprise using an automated document management system described herein. In some embodiments, provided herein are computer-implemented methods for document management. For example, disclosed herein are computer-implemented methods comprising detecting user selection of a document, applying one or more anti-counterfeit features and/or a unique identifier to each page of the document to produce a marked document, issuing the marked document to the user, and reconciling a copy of the marked document with the marked document issued to the user. The computer-implemented methods may comprise using a computer comprising computer-readable code. The computer-readable code is configured to detect the user selection of a document, apply the one or more anti-counterfeit features and/or a unique identifier to each page of the document to produce a marked document, issue the marked document to the user, and reconcile a copy of the marked document with the marked document issued to the user. For example, the computer-implemented method may comprise using a computer comprising a computer-readable code and a processor, wherein the computer-readable code is configured to instruct the processor to detect the user selection of a document, apply the one or more anti-counterfeit features and a unique identifier to each page of the document to produce a marked document, issue the marked document to the user, and reconcile a copy of the marked document with the marked document issued to the user.

The disclosure is not limited by the method of applying one or more anti-counterfeit features and/or one or more unique identifiers to each page of a document to produce a marked document, nor by the type or form of anti-counterfeit feature or unique identifier. The one or more anti-counterfeit features and/or the one or more unique identifiers may be applied to each page using any suitable method. Suitable methods include, for example, application to each page of a paper copy by directly applying the one or more anti-counterfeit features and/or the unique identifier to each page during the printing process, stamping each page of a paper copy with the one or more anti-counterfeit features and/or the unique identifier immediately after printing the page, or electronic application to each page of an electronic copy. In some embodiments, the one or more anti-counterfeit features and the one or more unique identifiers may be applied by the same method. In other embodiments, the one or more anti-counterfeit features may be applied by a different method. For example, the one or more anti-counterfeit features may be applied to each page directly during the printing process, and the unique identifier may be applied to each page immediately after printing (e.g. by stamping). Alternatively, the unique identifier may be applied to each page directly during the printing process and the one or more anti-counterfeit features may be applied to each page immediately after printing.

In accordance with any of the embodiments described herein, each of the one or more anti-counterfeit features may be applied to any suitable location on each page of the document. For example, each of the one or more anti-counterfeit features may be placed in the top margin, side margins, or bottom margins of a page in the document. In some embodiments, each of the one or more anti-counterfeit features may be applied to the corner of a page in the document (e.g. the top right corner, the top left corner, the bottom right corner, or the bottom left corner of the page). The location of the one or more anti-counterfeit features may vary from page to page or may remain the same for two or more pages in the document. In some embodiments, the anti-counterfeit measure is readily and easily perceptible by a user (e.g., via simple visual inspection of a document). In other embodiments, the anti-counterfeit measure is not readily and easily perceptible by a user (e.g., a user is not able to see or perceive the anti-counterfeiting measure via simple visual inspection of the document). Non-limiting examples of anti-counterfeiting measures include, but are not limited to, numeric identifiers, symbolic identifiers, physical watermarks, digital watermark (e.g., embedded in an image), and/or combinations thereof.

In some embodiments, each page of the document may comprise one or more anti-counterfeit features applied to a specific location on the page. Each page of the document may comprise the same anti-counterfeit feature as one or more other pages in the document. For example, each page of the document may comprise the same anti-counterfeit feature. Alternatively, each page of the document may comprise a different anti-counterfeit feature. In other embodiments, each page of the document may comprise multiple anti-counterfeit features applied to specific locations on each page. The anti-counterfeit features may be the same across multiple pages of the document. For example, the anti-counterfeit features may be the same on each page of the document. Alternatively, the anti-counterfeit features may differ on each page of the document. The placement of the anti-counterfeit features may be the same or may vary from page-to-page. For example, each page may comprise the same anti-counterfeit features in the same place on each page. Alternatively, each page may comprise the same anti-counterfeit features, but the anti-counterfeit features may be placed in different locations in one or more pages of the document. In some aspects of the disclosure, the location of the anti-counterfeit measure itself may be a component of the anticounterfeit measure (e.g., the location of the anti-counterfeit features may be formatted to take alternative positions across multiple pages of the document).

Any suitable anti-counterfeit feature or combination of anti-counterfeit features may be used in any of the embodiments described herein. Any suitable number of anti-counterfeit features may be used. In some embodiments, one anti-counterfeit feature may be used. In some embodiments, two anti-counterfeit features, three anti-counterfeit features, four anti-counterfeit features, or five anti-counterfeit features may be used. In some embodiments, more than five anti-counterfeit features may be used. In general, the one or more anti-counterfeit features are selected to enable the automated document management system to distinguish between a copy of the marked document and the marked document originally issued to the user. For example, the one or more anti-counterfeit features may be selected to distinguish between a scanned copy of the marked document (e.g., a scanned copy produced by physically placing a document through a scanning device) or an electronically produced copy of the document (e.g., a digital/electronic copy of a digital/electronic document) and the marked document originally issued to the user.

The invention is not limited by the type of anti-counterfeit measure used. Any anti-counterfeit measure can be used including, but not limited to, numeric identifiers, symbolic identifiers, physical watermarks, digital watermark (e.g., embedded in an image), and/or combinations thereof. In some embodiments, each of the one or more anti-counterfeit features are independently selected from a colored shape (e.g. square, triangle, rectangle, hexagon, etc.) or clusters of shapes, a background overlay, a watermark, random dot clusters, and small lines in various orientations. The clusters and/or lines could be in a variety of standardized shapes or forms that are readily distinguishable from printed text. The clusters and/or lines can be any suitable color or variety of colors.

In some embodiments, one anti-counterfeit feature may be a colored shape. Any suitable shape may be used, including triangles, squares, rectangles, hexagons, etc. The colored shape may be any suitable color. For example, the colored shape may be red, orange, yellow, green, blue, purple, etc. In some embodiments, the colored shape may be a combination of colors. The colored shape may be used to allow any black and white copies of the marked document to be easily distinguishable from the original marked document issued to the user.

In some embodiments, the anti-counterfeit feature may be a watermark. For example, one or more pages of the document may comprise a watermark that is set at a low dots per inch (DPI) value. For example, the DPI value may be set at a value that is typically undetectable by the human eye. In such embodiments, a scanner may not be able to replicate the watermark, thus enabling one to differentiate between the marked document issued to the user and a scanned copy of the marked document. In some embodiments, the watermark is a digital watermark embedded in an electronic image of the document. In some embodiments, a combination of watermarks may be used.

In some embodiments, the anti-counterfeit feature may be a cluster of dots in random locations. For example, one or more pages may contain a cluster of yellow dots in random locations. The yellow color may be difficult to scan correctly, thereby enabling one to differentiate between the marked document issued to the user and a scanned copy of the marked document.

In some embodiments, the anti-counterfeit feature may be a series of small lines in various orientations. For example, the anti-counterfeit feature may be a series of small red lines in various orientations. The automated document management system may record the position and orientation of each line for each page. In some embodiments, numerals and/or text are used as in an anti-counterfeit measure. For example, numbers and/or text may be used independently or together with one or more other anti-counterfeiting measures.

In accordance with any of the embodiments described herein, other suitable anti-counterfeit features may be used. For example, the scanners used in network with the system may comprise plates that are etched with any desired unique symbol. Accordingly, documents that are scanned using the network scanners would be marked with the unique symbol, thereby allowing for differentiation between the original marked document issued to the user and a scanned copy of the marked document. Alternatively or in combination, the network scanners may be programmed to shut-down the scanner in the event that a user attempts to make a scanned copy (e.g., a color copy). This feature would be useful in embodiments wherein the marked document anti-counterfeit features that rely at least in part on the use of color. For example, in embodiments wherein a page comprises yellow dots as an anti-counterfeit features, shutting down the scanners in the event that a user attempts to print in color may be a useful additional anti-counterfeit feature.

In some embodiments, the unique identifier comprises a user identification feature and a page identification feature. The user identification feature provides an identification that allows the automated document management system to effectively track which user is requesting the document. For example, the user identification feature may identify a specific employee of the company that is selecting a document from the document library for use by the employee. Suitable user identification features include, for example, a user pin number, a user serial number, a user fingerprint, a user passcode, a unique employee badge number, or a combination thereof. In some embodiments, the user identification feature may be the fingerprint of the user. In other embodiments, the user identification feature may be a serial number assigned to the user. In other embodiments, the user identification feature may be a pin number assigned to the user. In some embodiments, the user identification feature may be a unique employee badge number.

The page identification feature provides a unique identification to each page of the document. In some embodiments, the page identification feature of each page may be independently selected from a page number, a page serial number, a page pin number, or a combination thereof. No two pages comprise the same page identification feature.

In some embodiments, the unique identifier comprises a barcode. For example, the unique identifier may comprise a 2-D barcode. For example, each page of the document may be labeled with a 2-D barcode comprising the user identification feature (such as a user serial number or a user pin number) and the page identification feature (such as a page serial number). In some embodiments, the unique identifier comprises a page identification feature, a user identification feature, and a 2-D barcode that comprises the page identification feature and the user identification feature. For example, each page of the document may comprise a page identification feature (e.g. a page number, a page serial number, a page pin number) and a user identification feature (e.g. a user pin number, a user serial number, a unique employee badge number) and a 2-D barcode that comprises the page identification feature and user identification feature.

The unique identifier may be placed in any suitable location on each page of the document. For example, the unique identifier may be placed in the top of the document or the bottom of the document. For example, the unique identifier may be placed in the top right corner, the top center, or the top left corner of the document. Alternatively, the unique identifier may be placed in the bottom right corner, the bottom center, or the bottom left corner of the document. In some embodiments, the unique identifier may be placed in a margin of the document (e.g. the left margin or the right margin). In some embodiments, each component of the unique identifier (i.e. the user identification feature and the page identification feature) are placed in the same location in the document. In such embodiments, the automated document management systems and methods for data management described herein allow for automatic reconciliation of each page by comparing the unique identifier (e.g., a 2-D barcode comprising both the user identification feature and the page identification feature in a single location) on each page of a copy of the marked document to the unique identifier on each page of the marked document originally issued to the user.

In other embodiments, the user identification feature and the page identification feature may be placed in different locations in the document. For example, the user identification feature may be placed in the top right corner of the document and the page identification feature may be placed in the bottom right corner of the document. In such embodiments, a multi-step (e.g., two-step, three-step, four-step, or more step) reconciliation method may be used. For example, the reconciliation may involve comparing the user identification feature in a first location and the page identification feature in a second location to the user identification feature and the page identification feature in each page of the document originally issued to the user.

The automated document management systems and methods for document management described herein further comprise issuing the marked document to the user. In some embodiments, the computer-readable code is further configured to issue the marked document for the user. For example, the computer-readable code may be further configured to instruct the processor to issue the marked document to the user. Issuing the document to the user may comprise any suitable form of providing the document to the user. For example, issuing the document to the user may comprise printing the document. For example, the computer-readable code may be configured to instruct the processor to print the marked document for use by the user. In some embodiments, the marked document may be printed on a printer that forms an integrated network with the automated document management system (e.g. a network printer). The user may then use the issued document for the desired purpose. In other embodiments, issuing the document to the user may comprise electronically transmitting the document to the user. For example, issuing the document may comprise e-mailing the document to the user, sending a link providing access to a downloadable copy of the document to the user, and the like. In such embodiments, the user may subsequently print the document on a suitable printer.

In some embodiments, the document management systems and methods for document management described herein further comprise keeping a record of which documents have been issued to users. For example, the computer-readable code can be configured to record which documents have been issued to various users and store this information. For example, the computer-readable code may be configured to instruct the processor to record which documents have been issued to various users and store this information as a list of documents awaiting reconciliation. In some embodiments, after reconciliation the documents can be removed from the list of documents awaiting reconciliation and/or labeled with any other suitable indication that the documents have been reconciled.

The automated document management systems and methods for document management described herein further comprise reconciling a copy of the marked document with the marked document issued to the user. For example, the computer-readable code may be further configured to reconcile a copy of the marked document with the marked document issued to the user. For example, the computer-readable code may be further configured to instruct the processor to reconcile a copy of the marked document with the marked document issued to the issue. Reconciliation may comprise reconciling a scanned copy of the marked document with the marked document originally issued to the user. In other embodiments, reconciliation may comprise reconciling an electronic copy of the marked document with the marked document originally issued to the user. In some embodiments, reconciliation comprises comparing the unique identifier on each page of the copy of the marked document to the unique identifier on each page of the marked document issued to the user. The reconciliation process therefore enables determination of, in part, whether pages that were issued to the user are the same pages that are subsequently attempted to be reconciled. For example, reconciliation may enable the processor to determine whether pages that were physically issued to the user are the same pages that the user scans after use. Alternatively, reconciliation may enable the processor to determine whether pages that are electronically/digitally issued to the user are the same pages that the user attempts to electronically reconcile after use.

In some embodiments, the copy of the marked document (e.g., an electronic copy or a picture of a physically scanned copy of a document) can be stored in a temporary location in the automated document management system. For example, the scanned copy of the marked document can be stored in a temporary folder, temporarily stored on an internal hard-drive, or temporarily stored on an external hard-drive. Upon successful completion of reconciliation, the reconciled copy of the marked document can be moved into a different location for long-term storage.

In some embodiments, the automated document management system will not permit a document that has already been issued (e.g., printed and/or reconciled) to be issued (e.g., printed) a second time. For example, the automated document management system may not permit the same user to re-print a document that has already been printed and/or reconciled. As another example, the automated document management system may not permit a second user to re-print a document that has already been printed and/or reconciled by a first user. For example, the computer-readable code may be configured to instruct the processor to report an error if a user attempts to re-print a document that has already been printed and/or reconciled.

In some embodiments, the user may use the marked document for the intended purpose and subsequently scan each page of the marked document using a scanner. Any suitable scanner may be used. In some embodiments, the scanner may be a scanner that form an integrated network with the automated document management system (e.g. a network scanner). In some embodiments, the automated document management system may form an integrated network with one or more network printers and one or more network scanners.

In some embodiments, the scanner may require the user to sign-in to the scanner prior to use. For example, the scanner may require the user to sign-in to the scanner using a user log-in which corresponds to the user identification feature present on each page of the document. For example, the scanner may require the user to log-in with a user fingerprint that matches the user fingerprint that serves as the user identification feature. As another example, the scanner may require the user to log-in with a user pin number and/or a user serial number that corresponds to the user pin number and/or user serial-number that serves as the user identification feature. As another example, the scanner may require the user to log-in with an employee badge number that corresponds to the employee badge number that serves as the user identification feature.

In some embodiments, the network scanner may have a function that enables automatic scanning of each page in the document, thereby eliminating the need for the user to manually scan and subsequently reconcile each page of the document. In some embodiments, the pages may be provided to the scanner in any orientation and the scanner will automatically rotate each page to enable proper reconciliation. For example, the scanner may automatically rotate each page to ensure that the unique identifier is in the proper location for reconciliation. As each page is automatically scanned, the automated document management system automatically reconciles each scanned page with each page of the marked document issued to the user. For example, the computer-readable code may be configured to instruct the processor to automatically compare the unique identifier on each page of the scanned copy of the marked document to the unique identifier on each page of the marked document issued to the user.

In some embodiments, the user may use the marked document for the intended purpose and subsequently generate an electronic copy of the marked document. For example, the user may be electronically/digitally issued a document, use the document for the intended purpose, and make an electronic copy of the marked document originally issued (electronically or digitally) to the user.

In some embodiments, the automated document management systems and methods for document management described herein may further comprise marking pages that have been reconciled and archiving the pages. For example, the computer-readable code may be further configured to mark pages that have been reconciled and archive reconciled pages. For example, the computer-readable code may be configured to instruct the processor to mark pages that have been reconciled and archive reconciled pages. In some embodiments, reconciled pages may be archived in a library on the computer. In some embodiments, reconciled pages may be archived in a document folder, an internal hard-drive, an external hard-drive, or other suitable means for archiving the pages.

In some embodiments, the automated document management systems and methods for document management described herein may further comprise reporting an error if one or more pages are unable to be reconciled and/or if a page is copied (e.g. by scanning or by generating an electronic copy) more than once. For example, the computer-readable code may be further configured to instruct the processor to report an error to the user if the processor is unable to reconcile one or more pages or if the processor detects that a page is copied more than once. In some embodiments, reporting an error causes the reconciliation process to pause. For example, the computer-readable code may be configured to cause the process to pause reconciliation if an error is reported. This gives the user the opportunity to fix the error and resume the reconciliation process.

In some embodiments, an error may be reported due to damage to one or more pages of the document. For example, an error may be reported due to damage to the unique identifier on one or more pages of the document. In such embodiments, manual reconciliation may be used. For example, if the unique identifier is a barcode and the automated document management system is unable to read the barcode, the user may manually scan the barcode and reconcile the document with the document originally issued to the user. In some embodiments, the one or more anti-counterfeit features may additionally assist with document reconciliation in the event that the system is unable to automatically reconcile one or more pages of a document. For example, if the automated document management system is unable to automatically reconcile one or more pages of the marked document (e.g. due to damage of the unique identifier), the user may manually superimpose one or more anti-counterfeit features of the scanned copy of the marked document over the marked document originally issued to the user, or vice-versa. For example, the user may manually superimpose the recorded positions of and orientations of the series of red lines of the marked document originally issued to the user over the same positions present in the scanned copy of the marked document.

In some embodiments, records of the entire process are kept. For example, records of which documents are requested, issued, and reconciled may be kept. Such records may be stored locally or remotely (e.g. cloud-based storage). In accordance with such embodiments, the document management system may comprise a processor and a memory that maintains the record of all activity of the document management system. For example, the memory that may comprise a record of all activity (e.g. documents that are requested, documents that are issued, documents that are awaiting reconciliation, documents that are reconciled, and which users are using the document management system).

### Exemplary Embodiments

The following exemplary embodiments are provided in order to demonstrate and further illustrate certain preferred embodiments and aspects of the present disclosure and are not to be construed as limiting the scope thereof.

### Embodiment 1

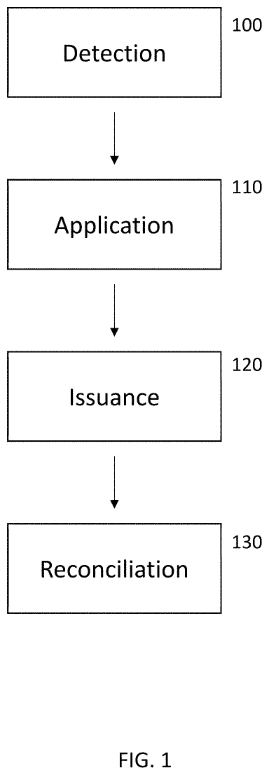

FIG. 1 is a flow chart broadly illustrating an embodiment of a computer-implemented method for document management as described herein. The method comprises detection (100) of user selection of a document, application (110) of one or more anti-counterfeit features and a unique identifier to each page of the document, issuance (120) of the marked document to the user, and reconciliation (130) of a copy of the marked document.

### Embodiment 2

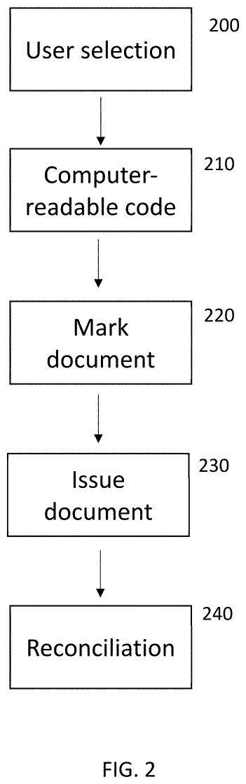

FIG. 2 is a flow chart broadly illustrating an embodiment of an automated system for document management as described herein. The system comprises computer-readable code (210) configured to detect user selection (200) of a document. Upon detecting user selection (200), the computer-readable code (210) is configured to mark the document (220) with one or more anti-counterfeit features and a unique identifier on each page, issue the document (230) to the user, and reconcile (240) a copy of the document with the marked document originally issued (230) to the user.

### Embodiment 3

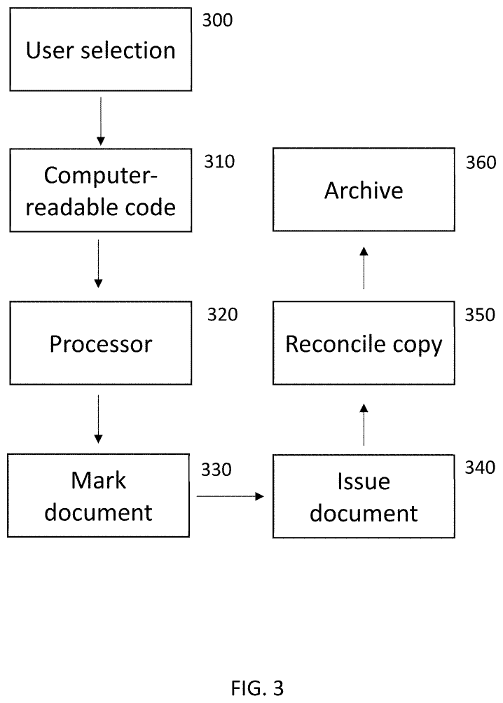

FIG. 3 is a flow chart broadly illustrating, an embodiment of an automated system for document management as described herein. The system comprises computer-readable code (310) configured to detect user selection (300) of a document. Upon detecting user selection (300), the computer-readable code (310) is configured to instruct a processor (320) to mark the document (330) with one or more anti-counterfeit features and a unique identifier on each page, issue the document (340) to the user, reconcile (350) a copy of the document with the marked document originally issued (340) to the user, and archive (360) a copy of the reconciled document.

1. An automated document management system comprising computer-readable code configured to perform the following steps in response to selection of a document by a user:
a) apply one or more anti-counterfeit features and a unique identifier to each page of the document to produce a marked document, wherein no two pages of the marked document comprise the same unique identifier;
b) issue the marked document to the user; and
c) reconcile a copy of the marked document with the marked document issued to the user.

2. The automated document management system of claim 1, further comprising a processor and a document library, wherein the computer-readable code is configured to instruct the processor to perform the steps a), b), and c) in response to selection of a document from the document library by the user.

3. The automated document management system of claim 1, wherein each unique identifier comprises a user identification feature and a page identification feature, wherein no two pages comprise the same page identification feature.

4. The automated document management system of claim 3, wherein:
i. the user identification feature comprises a user pin number, a user serial number, a user fingerprint, a user passcode, a unique employee badge number or a combination thereof;
ii. the page identification feature comprises a page number, a page serial number, a page pin number, or a combination thereof; or
iii. the user identification feature comprises a user pin number, a user serial number, a user fingerprint, a user passcode, a unique employee badge number, or a combination thereof and the page identification feature comprises a page number, a page serial number, a page pin number, or a combination thereof.

5. The automated document management system of claim 1, wherein each unique identifier comprises a 2-D barcode.

6. The automated document management system claim 1, wherein each of the one or more anti-counterfeit features are independently selected from a colored shape, a background overlay, a watermark, random dot clusters, and small lines in various orientations.

7. The automated document management system of claim 1, wherein the computer-readable code is further configured to archive the copy of the marked document following reconciliation.

8. The automated document management system of claim 1, further comprising one or more network printers and one or more network scanners that form an integrated network with the automated document management system, wherein issuing the marked document to the user comprises printing the marked document on a network printer and wherein the copy of the marked document is a copy generated by scanning the document issued to the user on a network scanner.

9. The automated document management system of claim 1, wherein the computer-readable code is configured to reconcile each page of the copy of the marked document by comparing the unique identifier on each page of the copy of the marked document to the unique identifier on each page of the marked document issued to the user.

10. The automated document management system of claim 9, wherein the computer-readable code is further configured to mark pages that have been reconciled and archive reconciled pages.

11. The automated document management system of claim 9, wherein the computer-readable code is further configured to report an error to the user and halt reconciliation if the automated document management system is unable to reconcile one or more pages or if a page is copied more than once.

12. A method for managing documents, comprising using the automated document management system of claim 1.

13. A computer-implemented method for document management, comprising:
a. Detecting user selection of a document;
b. Applying one or more anti-counterfeit features and a unique identifier to each page of the document to produce a marked document, wherein no two pages of the marked document comprise the same unique identifier;
c. Issuing the marked document to the user; and
d. Reconciling a copy of the marked document with the marked document issued to the user.

14. The method of claim 13, wherein:
i. the user identification feature comprises a user pin number, a user serial number, a user fingerprint, a user passcode, a unique employee badge number or a combination thereof;
ii. the page identification feature comprises a page number, a page serial number, a page pin number, or a combination thereof; or
iii. the user identification feature comprises a user pin number, a user serial number, a user fingerprint, a user passcode, a unique employee badge number, or a combination thereof and the page identification feature comprises a page number, a page serial number, a page pin number, or a combination thereof.

15. The method of claim 13, wherein each unique identifier comprises a 2-D barcode.

16. The method of claim 13, wherein each of the one or more anti-counterfeit features are independently selected from a colored shape, a background overlay, a watermark, random dot clusters, and small lines in various orientations.

17. The method of claim 13, wherein issuing the marked document to the user comprises printing the marked document using one or more network printers, wherein the one or more network printers form an integrated network with the computer.

18. The method of claim 13, wherein reconciling comprises comparing the unique identifier on each page of the copy of the marked document to the unique identifier on each page of the marked document issued to the user.

19. The method of claim 18, further comprising marking pages that have been reconciled and archiving reconciled pages.

20. The method of claim 13, further comprising reporting an error to the user if computer is unable to reconcile one or more pages or if the computer detects that a page is copied more than once, wherein reporting an error causes the computer to halt reconciliation.
